(19) United States
(12) Patent Application Publication
(10) Pub. No.: US 2008/0223761 A1
(43) Pub. Date: Sep. 18, 2008

(54) Sealing Mechanism and Associated Sealing Method for Screening Machines

(75) Inventors: Brady P. Ballman, Loveland, OH (US); Nicholas P. Gardner, Cincinnati, OH (US); James G. Potter, Harrison, OH (US)

Correspondence Address: WOOD, HERRON & EVANS, LLP, 2700 CAREW TOWER, 441 VINE STREET, CINCINNATI, OH, 45202, US

(73) Assignee: ROTEX, INC., Cincinnati, OH (US)

(21) Appl. No.: 11/685,811

(22) Filed: Mar. 14, 2007

(51) Int. Cl. B07B 1/28

(52) U.S. Cl. 209/309; 209/404

(57) ABSTRACT

A screening machine includes a vibratory carrier and a vibratory drive operatively coupled to the vibratory carrier for imparting vibratory motion thereto. The screening machine includes a screen assembly selectively coupled to the vibratory carrier so that the vibratory motion is transmitted to the screen assembly. A sealing mechanism including at least one rotary cam having a cam surface and at least one actuator being accessible to a user of said screening machine is coupled to the rotary cam. Actuation of the actuator to rotate the cam urges the screen assembly and the carrier into sealing engagement with a confronting surface of the screening machine. The screening machine further includes at least one stop positioned relative to the sealing mechanism to limit rotational movement of the rotary cam in at least one direction.

### FIELD OF THE INVENTION

This invention relates to screening machines of the type used to separate or classify mixtures of solid particles of different sizes. The invention also relates to screening machines of the type used for liquid/solid separations, i.e., for separating solid particles of specific sizes from a liquid in which they are carried. More particularly, the invention relates to a mechanism and method for sealing components within the screening machine.

### BACKGROUND OF THE INVENTION

In screening machines of the type described, a screen (which may be woven, an aperture plate or another design) is mounted in what is often called a “screen frame” or “screen deck” which includes a supporting peripheral frame around the perimeter of the screen. Typically associated with this screen frame are other material handling elements which are moved with the screen frame and form walls or partitions above or below the screen frame for containing the liquid and/or particulate materials adjacent to the screen and directing them to appropriate outlets. These elements may include a top cover and a pan beneath the screen frame. In the case of screening machines with multiple screens or deck units, spacer pans or frames are provided between the multiple screens.

The screen frames are often removed from the screening machines for cleaning, replacement, readjustment or installation of a screen of a different mesh size or the like. The screen frame is releasably mounted to a carrier, frame, table or box to which vibratory motion is imparted, typically by one or more eccentric motors or other means of excitation. The carrier, frame, table or box is referred to herein as a “vibratory carrier”. The vibratory carrier may be moved in oscillatory, vibratory, gyratory, gyratory reciprocating, fully gyratory, rotary or another type of motion or combinations thereof, all of which are herein collectively referred to as “vibratory” motion or variations of that term.

In large commercial screening machines, the weight of the various components including the screen assembly carried by the vibratory carrier, and the weight of the material being processed on the screen assembly may total several hundred pounds or more. This presents a very substantial inertial mass which resists the changes of motion applied thereto by the vibratory drive acting through the vibratory carrier. As a result of these inertial forces, a relative motion may exist between the vibratory carrier and the screen frame. Known screen frames and vibratory carriers are each constructed of metal which could result in significant noise, wear or damage due to the relative motion or rubbing action therebetween. The resulting impact forces between the screen frame and vibratory carrier significantly increase the stresses on the components and reduce their useful life.

Reducing the metal-to-metal contact minimizes the wear on the various metal components and the noise associated with the operation of the screening machine. In some screening machines, a seal is provided between the screen frame and adjacent components such as other screen frames or the vibratory carrier. The seal prevents the escape of material from the screen frame and reduces the detrimental metal-to-metal contact between the screen frame and adjacent components. Certain screen frame designs may not be sealed or secured relative to the remainder of the screening machine, particularly in larger screening machines. This results in the above-described metal-to-metal contact between the screen frame and the remainder of the screening machine and prevents the screening of very fine material, such as sand or the like. The screen frames in known larger screening machines may be inserted and/or removed from the machine in a generally horizontal direction through an opening or slot at, for example, the head or foot end of the machine. This method of installation and removal of the screen frame is detrimental to known sealing arrangements because a seal which would engage the screen frame could be torn or damaged during the installation/removal and/or reinsertion of the screen frame. In other known screening machines, the screen frame may be inserted vertically, typically from the top of the machine.

One known sealing mechanism for screening machines is disclosed in U.S. Pat. No. 5,226,546 which relates to a pneumatic seal that is inflated to raise up the screen frame for engagement with a seal. However, pneumatic systems by their very nature utilize a working fluid which may leak, thereby lowering the seal pressure. Furthermore, pneumatic systems require an air source at the machine location and traditionally are only used with the insertion/removal of the screen frame through the top of the machine in a generally vertical direction. Furthermore, screening machines with multiple screens and screen frames may require many or all of the screen frames to be removed for access to an individual screen frame. Furthermore, inspection of the resulting seal in pneumatic systems is not readily available.

Known alternatives to pneumatic sealing systems for screening machines include mechanical clamps or locks located at a number of spaced locations on the sides of the machine. One example of this type of known mechanism is disclosed in U.S. Pat. No. 5,392,925. However, to clamp each of the screens in place, the user must progressively move along a first side of the machine tightening and adjusting each of the individual mechanism and then proceed to the opposite side of the machine and repeat the same procedure. This mode of operation is inefficient, time consuming and inconvenient for the user. Additionally, the user cannot easily inspect the resulting seal when going from clamp site to clamp site in such systems. Furthermore, the screen frames utilized in screening machines with known mechanical sealing mechanisms must be robust and heavy because they are supported at individual spaced locations by the clamps.

U.S. Pat. No. 6,070,736 discloses a sealing mechanism including ramps having linear cam surfaces to bring a vibratory carrier respectively into and out of sealing engagement. A problem with the sealing mechanisms of this type may include the opportunity for a technician or user of the machine to advance the cam surface out of position thereby jamming the carrier into the machine.

Therefore, it is apparent that there is a need for a sealing mechanism and method for screening machines which avoids metal-to-metal contact between the screen frame and adjacent components of the screening machine without the disadvantages associated with known pneumatic or mechanical sealing systems of the prior art.

### SUMMARY OF THE INVENTION

In accordance with an embodiment of the invention, a screening machine includes a vibratory carrier and a vibratory drive operatively coupled to the carrier for imparting vibratory motion thereto. The screening machine includes a screen assembly having at least one screen mounted to a peripheral screen frame, which is selectively coupled to the carrier so that the vibratory motion is transmitted to the screen assembly. A sealing mechanism including at least one rotary cam having a cam surface and at least one actuator being accessible to a user of the screening machine is coupled to the rotary cam.

Actuation of the actuator to rotate the cam urges the screen assembly and the carrier into sealing engagement with a confronting surface of the screening machine. The screening machine further includes at least one stop positioned relative to the sealing mechanism to limit rotational movement of the cam in at least one direction.

The screening machine may include two rotary cams coupled to the actuator. Two stops may be positioned relative to the sealing mechanism to limit rotational movement of the cam in a clockwise direction and a counter-clockwise direction. The two stops may define a limiting cam which is coaxial with the rotary cam.

At least one rotary cam may lie proximate a first edge on the peripheral screen frame and the screening machine may include a second rotary cam disposed proximate a second edge on the peripheral screen frame, which is disposed opposite the first edge.

A screening machine in one embodiment includes at least one stop preventing rotation of the rotary cam beyond about 110° from a lowest vertical position of the screen assembly and the carrier. The stop prevents rotary motion of the rotary cam in one direction beyond a lowest vertical position of the screen assembly and the carrier. In another aspect of one embodiment, a cam has a surface portion adapted to permit rotary motion of the rotary cam beyond a highest vertical position of the screen assembly and the vibratory carrier.

A screening machine according to this invention may include a rotary cam having a cam surface configured such that a tool driving the actuator is in a generally horizontal orientation when the screen assembly and the carrier reach a highest vertical position. The screening machine may further include a bracket, such that the at least one stop is integrally formed with the bracket.

In another embodiment, a method of sealing a screen frame having a screen within a screening machine includes inserting the screen frame and screen within a vibratory carrier of the screening machine. The vibratory carrier imparts vibratory motion to the screen frame and the screen during use of the screening machine which includes a sealing member being positioned on a portion of the vibratory carrier.

In another aspect of this embodiment, the method includes actuating a sealing mechanism having portions extending along a length of at least one side of the screen frame from an end of the screen frame. Such actuation is effected by rotating a rotary cam to urge the vibratory carrier and screen frame into and out of sealing engagement with corresponding portions of the screening machine. The method also includes rotating the rotary cam until a first stop is reached positioned to restrict rotational movement of the rotary cam in at least one direction.

The invention may also include rotating the rotary cam to urge the vibratory carrier and screen frame out of sealing engagement with corresponding portions of the screening machine to engage a second stop positioned to restrict movement of the rotary cam in a direction beyond a lowest height of the vibratory carrier and screen frame.

Advantageously, by including at least one rotary cam having at least one stop to prevent rotational motion thereof, the screening machine described herein has a sealing mechanism that effectively seals the screen frame without damaging it or adjacent components.

### BRIEF DESCRIPTION OF THE DRAWINGS

These and other objectives and advantages will become readily apparent to those of ordinary skill in the art from the following description of embodiments of the invention and from the drawings in which:

FIG. 1 is a perspective view of an exemplary screening machine;

FIG. 2 is an enlarged elevation view of one embodiment of a sealing mechanism of the screening machine of FIG. 1;

FIG. 3 is a view similar to that of FIG. 2 showing a point in the rotation of a cam of the sealing mechanism of FIG. 2;

FIG. 4 is a view similar to those of FIGS. 2-3 showing a subsequent point in the rotation of the cam of FIG. 3;

FIG. 5 is a perspective view of a rotational cam assembly and actuator according to one embodiment of the sealing mechanism of FIGS. 2-4;

FIG. 6 is an elevation view of an exemplary embodiment of a primary cam of the sealing mechanism of FIGS. 2-5;

FIG. 7 is an elevational view of another exemplary embodiment of a primary cam of the sealing mechanism of FIGS. 2-5; and

FIG. 8 is a perspective view of a bracket according to one embodiment of the sealing mechanism of FIGS. 2-5.

### DETAILED DESCRIPTION

With reference to FIG. 1, an exemplary embodiment of a screening machine 10 in which this invention may be used is shown. Screening machines of many types are sold commercially by Rotex, Inc. of Cincinnati, Ohio, the assignee of this invention. However, this invention is not limited to any particular type of screening machine design or component and the machine and associated components depicted and disclosed herein are shown for illustrative purposes.

The screening machine 10 includes an inlet port 12 near an inlet section 14 proximate a head end 16 of the machine 10. The screening machine 10 may also include a top cover 18 in any one of a variety of forms. Particulate or other material to be screened is fed into the inlet port 12 from a hopper (not shown) for screening and processing by the machine 10.

The screening machine 10 is supported structurally by a base frame 20 including beams 22 connected together by laterally oriented struts 24 on each end of the screening machine 10. The screening machine 10 includes an electric motor 26 coupled to a drive weight (not shown) to impart an oscillatory, vibratory, gyratory, gyratory reciprocating, fully gyratory, other motion or combinations thereof (herein collectively referred to as “vibratory” motion or variations of that term) to at least the head end 16.

Within a screening chamber of the screening machine 10, one or more screen assemblies 28 are each mounted in combination to form one or more screen decks 30 to receive the material being screened from the inlet port 12 at the head end 16 of the machine 10. The screen assemblies respectively include screen panels 28, which are mounted on slightly sloping planes (about 4°) with the head end thereof being slightly elevated relative to a foot end so that during the screening process the material advances, in part by gravity, over the screen panels 28 toward the foot or discharge end 32 of the machine 10. Even though the screen panels 28 of the screening machine 10 may be on a slightly sloping plane, to provide a reference for the purposes of clarity herein, these components will be considered to be generally horizontal and the direction perpendicular or orthogonal to the screen panels 28 will generally be referred to as a vertical orientation, direction or attitude. The direction of travel of the material being screened from the head end to the foot end across the screen panels 28 is referred to as the longitudinal direction and the perpendicular orientation extending from side to side on the screen panels is a lateral direction.

In the embodiment of the screening machine 10 shown in FIG. 1, upper and lower screen decks 30a,b each include four screen panels 28 mounted generally coplanar with each other in the associated screen deck 30a,b. Accordingly, as the material to be screened is deposited from the inlet port 12 onto the upper screen deck 30a, the vibratory motion of the screening machine 10 advances the material longitudinally across the top of the screen panels 28 of the upper screen deck 30a toward the foot end 32. Appropriately sized and configured material passes through the upper screen deck 30a and falls onto the lower screen deck 30b. The screen panels 28 of the upper screen deck 30a may include a fine mesh screen material 34 adjacent the inlet port 12 through which dust and other fine particulate matter passes for collection and discharge. Certain material also passes through the upper screen deck 30a and is deposited on the lower screen deck 30b. Therefore, the lower screen deck 30b is included to provide an additional separating mechanism for the appropriately sized particles to pass through the second lower screen deck 30b for collection in the lower pan (not shown) and discharge through an outlet or exit section 36.

The unacceptably sized particles remain atop the first upper screen deck 30a and fall off the terminal edge thereof into a collection basin (not shown) for discharge through the outlet section 36. Material that passes through the upper screen deck 30a and remains atop the lower screen deck 30b falls off the terminal edge thereof and into the collection basin for discharge through a reject port (not shown). The discharge and reject ports are separated by a baffle (not shown) to keep the classified particles separate from one another.

With continued reference to FIG. 1, one or more doors 38 are each pivotally connected by a hinge 40 to a lateral side 42 of the screening machine 10. When opened, the doors 38 provide access for insertion and removal in the lateral direction of the screen panels 28. It will be appreciated that although one side 42 of the screening machine 10 is shown in FIG. 1, additional doors on the opposite side of the screening machine 10 may also be provided. The screen panels 28 may be inserted laterally or perpendicularly to the longitudinal direction of travel of the material being screened in the screening machine 10 from the head end 16 to the foot end 32 of the machine 10.

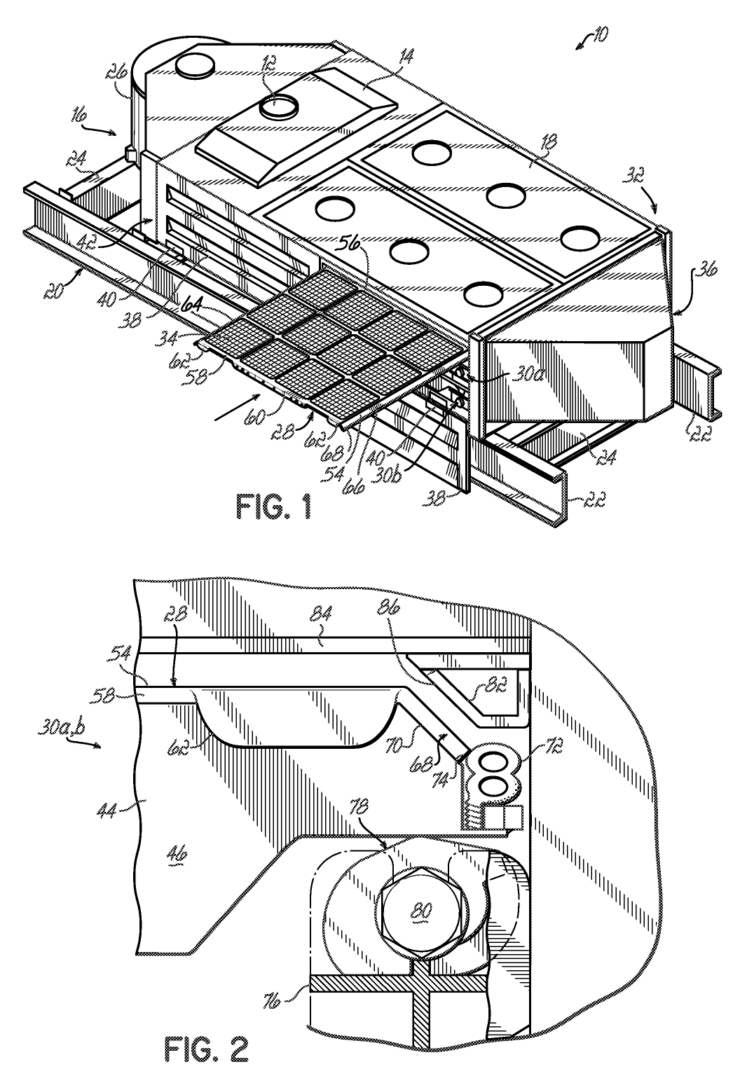

With reference to FIGS. 1-2, when the screen panel 28 is inserted into the screening machine 10, it is supported on a vibratory carrier 44. In one embodiment, the vibratory carrier 44 may include a ball tray 46 capturing a number of balls or other agitation producing members (not shown) which repeatedly impact the screen panel 28 to dislodge particulate material that might accumulate on the screen material 34 and inhibit occlusion of the screen material 34 as is well known in the art.

One embodiment of the screen panel 28 includes a generally perforated mesh screen material 34 including a number of intersecting longitudinal and lateral threads, wires or strings which are oriented orthogonally to each other to provide appropriately sized and configured openings in the mesh screen material 34 to prevent/permit the passage particulate material therethrough. The screen panel 28 includes a generally rigid perimeter frame 54 having a leading side edge 56 opposite from a trailing side edge 58.

With continued reference to FIGS. 1-2, the leading side edge 56 of the screen panel frame 54 may be inserted laterally into the screening machine 10 while a user or operator grasps the trailing side edge 58 for manipulation. In particular, a downwardly turned elongate handle 60 is formed on the trailing side edge 58 of the screen panel 28. In one embodiment, the handle 60 is oriented about 90° relative to the plane of the screen panel 28 and provides a convenient and easy access for the user or technician to grasp or manipulate the screen panel 28. Additionally, the handle 60 or adjacent surfaces of the screen panel frame 54 provide a convenient location for identifying indicia and labels indicating various service parameters, design characteristics and other aspects of the screen panel 28.

One or more tabs 62 each located proximate a head end 64 or a tail end 66 of the screen frame 54 are located along the trailing side edge 58 of the frame. The tabs 62 are each oriented about 90° relative to the plane of the screen panel 28 and along with the handle 60 provide a convenient location for the user or technician to grasp and manipulate the screen panel frame. Likewise, upon insertion of the screen panel 28 into the screening machine 10, the tabs 62 and handle 60 provide a detent when juxtaposed against the vibratory carrier 44 for proper orientation and location of the screen panel 28 in the screening machine 10.

With continued reference to FIGS. 1-2, in another aspect of the illustrated embodiment of the screen panel 28 and associated frame 54, beveled edges or lips 68 extend along the longitudinal head end 64 and/or foot end 66 of the screen panel frame 54. Each lip 68 is oriented about 45° relative to the upper surface or plane of the screen panel 28 and extends substantially along the entire width of the frame 54. While the lips 68 are shown along both the longitudinal head and foot ends 64, 66 of the screen panel frame 54, one of ordinary skill in the art will readily appreciate that the lip 68 may be provided at neither, either or both of the head and foot ends 64, 66.

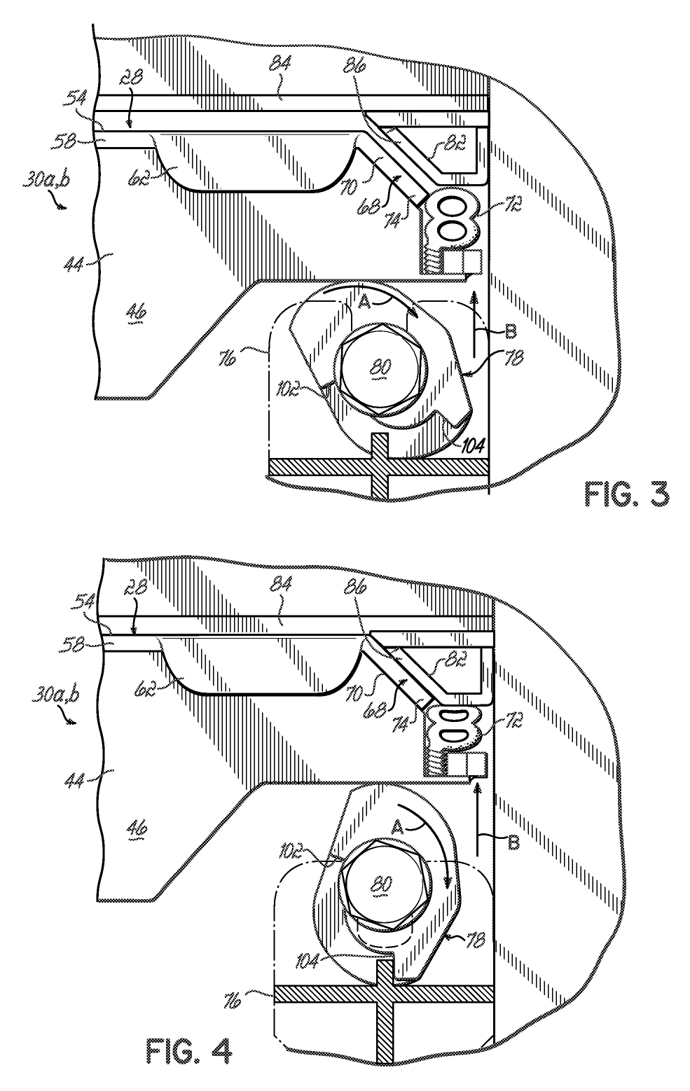

With reference to FIGS. 2-4, the screening machine 10 includes a sealing mechanism which will now be described. One example of a sealing mechanism is disclosed in U.S. patent application Ser. No. 11/382,353, filed May 6, 2006, and hereby incorporated by reference. The downwardly turned bevel lips 68 along the head and foot ends 64, 66 of the screen panel frames 54 are supported by a similarly inclined face 70 of the vibratory carrier 44 as shown in FIG. 2. A compressible seal member 72 lies juxtaposed to the terminal edge 74 of the lip 68 and is mounted in the carrier 44. Likewise, a lower surface of the screen panel frame 54 is supported along a similarly configured profile of the carrier 44 as shown in FIG. 2.

The sealing mechanism also includes a bracket 76 that cooperates with a rotational cam assembly 78 sitting thereon and which supports the carrier 44. The rotation of the cam assembly 78 is accomplished by an actuator 80 accessible to the operator or technician when the door 38 of the screening machine 10 is open. The screening machine 10 also includes a downwardly depending channel 82 initially spaced from the bevel lip 68 of the screen frame 54 as shown in FIG. 2.

With continued reference to FIGS. 2-4, upon rotation in the direction of arrow A (i.e., clockwise) of the actuator 80, the cam assembly 78 is rotated, thereby raising the carrier 44 and screen panel 28 supported thereon upwardly into sealing engagement with an upper portion 84 of the screen deck 30a, b as shown in FIG. 3. As the carrier 44 supporting the screen panel 28 is raised, a face 86 of the channel 82 is juxtaposed against the bevel lip 68 of the screen panel frame 54 and the seal member 72 is compressed against the channel 82. As a result, the upper portion 84 of the screen deck 30a, b and upper surface of the screen panel frame 54 are sealed to prevent and inhibit the discharge of material being screened. In another aspect of this embodiment, the orientation of the seal member 72 is generally parallel with the lateral direction in which the screen panel 28 is inserted and removed respectively into and from the machine 10.

While the exemplary embodiment of FIGS. 2-4 is depicted having a vibratory carrier 44 and screen panel frame 54 capable of sealing engagement with an upper portion of a deck 30a, b, persons of ordinary skill in the art will readily appreciate that, alternatively, the vibratory carrier 44 and screen panel frame 54 or any other part of the screen assembly may be capable of sealing engagement with any other suitably chosen part of the screening machine 10, such as, for example, a fixed support frame.

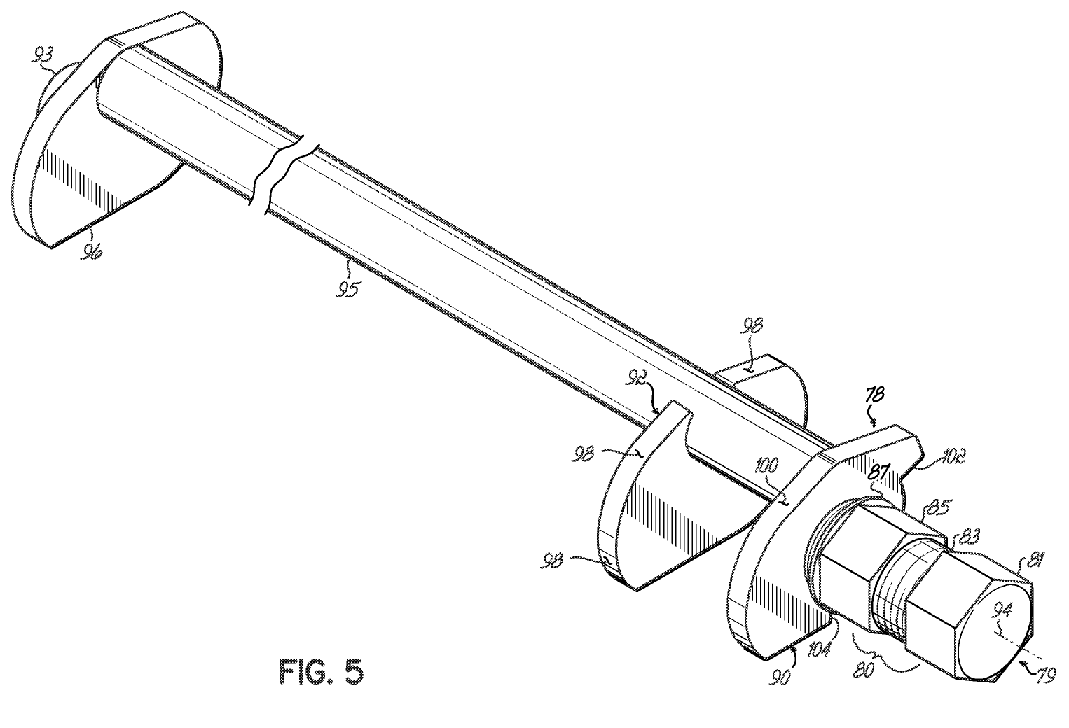

With reference to FIG. 5, the actuator 80 in this exemplary embodiment includes a conventional bolt 79 having a hex head 81 and a threaded body section 83. The actuator 80 further includes a locking nut 85 threadably engaged with the threaded body section 83 and a conventional serrated washer 87 that receives the threaded body section therethrough. The threaded section 83 is threadably engaged within a correspondingly threaded aperture 89 in the rotational cam assembly 78 such that the washer 87 lies between the locking nut 85 and the threaded aperture 89. The actuator 80 cooperates with the cam assembly 78 and bracket 76, as described below.

The rotational cam assembly 78 includes a limiting cam go and a primary cam 92, both disposed generally proximate the trailing side edge 58 and both rotational about an axis 94, as well as a shaft 95 supporting both cams go, 92 and extending in the direction of the head and foot ends 64, 66 of the screen panel frame 54. The rotational cam assembly 78 may further include a secondary cam 96 supported by the shaft 95, disposed generally proximate the leading side edge 56 of the screen panel frame 54, and generally similar in profile to the primary cam 92. A protrusion 93 may be also present extending from the secondary cam 96 and engageable with a slot (not shown) in the screening machine 10 to facilitate rotation of the secondary cam 96 about the axis 94. As such, the leading and trailing side edges 56, 58 of the screen panel frame 54 may be lifted in unison as the actuator 80 is rotated, thereby maintaining the screen panel 28 generally horizontal during raising and lowering thereof.

In another aspect of this embodiment, the locking nut 85 permits locking of the angular position of the primary cam 92 and thereby the corresponding positions of the carrier 44 and screen panel 28 with respect to the screening machine 10. Persons of ordinary skill in the art will readily appreciate that, alternatively, the sealing mechanism may include any other type of fastener or structure capable of providing the locking functionality of locking nut 85, or even include no locking fastener or device at all.

With continued reference to FIG. 5, the primary cam 92 includes a profile defined by serially disposed arcuate and flat surfaces 98 such that rotation of the actuator 80 in a specified direction results in raising and lowering of the screen panel 28 and subsequent sealing thereof and of the carrier 44 against the surface 84 of the screen deck 30a, b, as described above.

In one embodiment, the surfaces 98 may be configured as shown in FIG. 2, wherein clockwise rotation of the actuator 80 results in raising of the carrier 44 and screen panel 28, while counter-clockwise rotation lowers these two components. Persons of ordinary skill in the art will appreciate the fact that the surfaces 98 may be configured such that, alternatively, clockwise rotation lowers the carrier 44 and screen panel 28 while a counter-clockwise rotation raises them. The surfaces 98 may be further configured such that different rising rates (i.e., increase in height of the carrier 44 and screen panel 28) are achieved corresponding to a given angular rotation of the primary cam 92. For example, and without limitation, the surfaces 98 may be configured to yield a higher rising rate in rotations between about 0° and about 60° from a the lowest position of the carrier 44 and screen panel 28 than the rising rate during the subsequent about 30°.

In another exemplary embodiment, the configuration of the surfaces 98 of the primary cam 92 may be designed such that the carrier 44 and screen panel 28 reach their maximum height when a wrench or the like tool driving the actuator 80 is in a generally horizontal position, thereby facilitating the application of torque by the operator to seal the carrier 44 and screen panel 28 against the surface 84 on the upper screen deck 30a, b or any other suitably chosen portion of the machine 10, as explained above. Moreover, the surfaces 98 may be configured such that the seal 72 and associated components are neither damaged nor compromised with any rotational motion of the primary cam 92, thereby extending the service life of the seal 72 while maintaining effective sealing and associated screening operations.

While the above exemplary configurations of the surfaces 98 describe them as contemplated configurations for the primary cam 92, persons of ordinary skill in the art will readily appreciate that the same are also applicable to the secondary cam 96, if present.

With reference to FIGS. 2-5, the cam assembly 78 includes a limiting cam go coaxial with the primary cam 92. The limiting cam go includes serially disposed surfaces 100 which may or may not be configured to match corresponding surfaces 98 on the primary cam 92. In one embodiment, the surfaces 100 may be configured such that the limiting cam go simply “floats” over (i.e., does not make contact with) the surfaces against which the primary cam 92 moves. The limiting cam go includes one or more limiting surfaces 102, 104 such that rotation in at least one direction (i.e. clockwise or counter-clockwise) is limited when one of such surfaces 102, 104 engages a stop block, to be described below. In the illustrative embodiment of FIGS. 2-5, the limiting cam go includes two limiting surfaces 102, 104 such that rotation of the primary cam 92 is limited in both, clockwise and counter-clockwise directions.

The clockwise limiting surface 102 is circumferentially disposed on the limiting cam go such that clockwise rotation is prevented beyond a point that may lead to damage to the primary and secondary cams 92, 96, screen panel frame 54, carrier 44, seal 72 or other components of the screening machine 10. In one exemplary embodiment, the clockwise limiting surface 102 may be configured such that it maximizes rotation of the cam at about 110° from the lowest position of the carrier 44 and screen panel 28.

Similarly, the counter-clockwise limiting surface 104 is circumferentially disposed on the limiting cam go such that counter-clockwise rotation is prevented beyond a desired position. In one exemplary embodiment, the counter-clockwise limiting surface 104 may be configured such that the primary cam 92 cannot rotate counter-clockwise from the lowest position of the carrier 44 and screen panel 28.

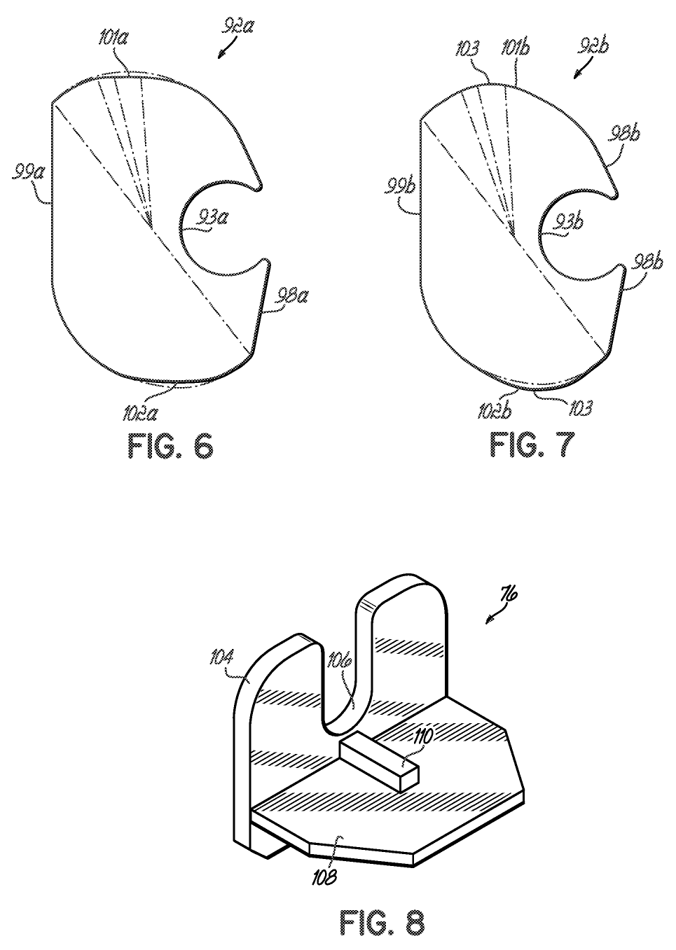

With reference to FIGS. 6-7, two illustrative embodiments of the primary cams 92a, 92b are depicted. These cams respectively include a notch 93a, 93b that receives the shaft 95 as well as an outer surface profile 99a, 99b. The configuration and design of each of the outer surface profiles 99a, 99b are suitably chosen to carry out functions such as those described above to determine, for example, the extent of any rotational motion of the primary cam 92a, 92b beyond a maximum height reached by the carrier 44 and screen panel 28.

With reference to FIG. 6, the outer surface profile 99a of the exemplary primary cam 92a includes respective top and bottom surface portions 101a, 102a. The top and bottom portions 101a, 102a are relative flattened such that relative motion of the carrier 44 and screen frame 28 with respect to the screening machine 10 levels out. More particularly, rotational motion of the primary cam 92a beyond a final position such as one corresponding to a maximum or minimum height of the carrier 44 and screen panel 28 yields little or no substantial change in position. Such configuration signals an operator that a maximum or minimum height of the carrier 44 and screen panel 28 has been reached.

With reference to FIG. 7, the outer surface profile 99b of the exemplary primary cam 92b includes respective top and bottom surface portions 101b, 102b. The top and bottom portions 101b, 102b are relative peaked such that an operator is made aware of the fact that a maximum or minimum height of the carrier 44 and screen panel 28 has been reached and passed. In another advantageous aspect of this embodiment, the peaks 103 of the top and bottom portions 101b, 102b provide locks that may make the locking nut 85 redundant. More particularly, once rotation of the primary cam 92b in a first direction is such that a peak 103 has been reached and passed, inadvertent rotation in a second, opposite direction is not likely to occur. This is because a relatively large torque is required to rotate the primary cam 92 in the second direction past a corresponding peak 103.

With reference to FIG. 8, and as mentioned above, the sealing mechanism includes a bracket 76 mounted on a screen deck 30a, b, and includes a wall 104 defining a notch 106. The wall 104 and notch 106 are disposed to support the cam assembly 78 and allow access to the actuator 80. In the illustrative embodiment of FIG. 8, the wall 104 and notch 106 are disposed such that a portion of the threaded body section 83 of the bolt 79 is received therein, for example, between the locking nut 85 and the serrated washer 87.

The bracket 76 includes a bottom plate 108 adapted to receive motion of the primary cam 92 along the surfaces 98 in ways well known to those of ordinary skill in the art. A stop block 110 is mounted on the bottom plate and provides a surface engageable against the limiting surfaces 102, 104 to prevent further rotational motion of the primary cam 92, as explained above. The dimensions and shape of the stop block 110 are such that suitable engagement is made possible against either or both of the limiting surfaces 102, 104 while permitting rotational movement of the primary cam 92. To that end, the stop block 110 may be integrally formed with or coupled to the wall 104 and/or the bottom plate 108 such that no extraneous surfaces such as welding points extend beyond the volume occupied by the stop block 110 and interfere with the motion of the primary cam 92.

With continued reference to FIG. 8, the stop block 110, wall 104, and bottom plate 108 are made of materials suitable to support the cam assembly 78 while resisting a force applied against it when any of the limiting surfaces 102, 104 engage the stop block 110. For example, and without limitation, the stop block 110, wall 104 and bottom plate 108 may be made of metal such as steel and further be integrally formed from one of several known casting processes known to those of ordinary skill in the art.

While the above description describes an embodiment including one bracket 76, persons of ordinary skill in the art will readily appreciate that in the case of embodiments including a secondary cam 96 (FIG. 5), a secondary bracket (not shown) similar to the bracket 76 may be disposed on the screening machine 10 to be in cooperating relationship with the secondary cam 96.

Accordingly, many further embodiments, applications and modifications of the invention will become readily apparent to those of ordinary skill in the art without departing from the scope of the invention and the inventors intend to be bound only by the claims appended hereto.

What is claimed is:

1. A screening machine comprising:
a vibratory carrier;
a vibratory drive operatively coupled to said vibratory carrier for imparting vibratory motion to said vibratory carrier;
a screen assembly being selectively coupled to said vibratory carrier so that the vibratory motion is transmitted to said screen assembly;
a sealing mechanism including at least one rotary cam and at least one actuator being accessible to a user of said screening machine and coupled to said rotary cam;
wherein actuation of said at least one actuator to rotate said at least one rotary cam urges said screen assembly and said vibratory carrier into sealing engagement with a confronting surface of said screening machine; and
at least one stop positioned relative to said sealing mechanism to limit rotational movement of said at least one rotary cam in at least one direction.

2. The screening machine of claim 1 further comprising two rotary cams coupled to said at least one actuator.

3. The screening machine of claim 1 further comprising two stops positioned relative to said sealing mechanism to limit rotational movement of said at least one rotary cam in a clockwise direction and a counter-clockwise direction, respectively.

4. The screening machine of claim 3 wherein said two stops further comprise a limiting cam coaxial with said at least one rotary cam.

5. The screening machine of claim 1 wherein said at least one rotary cam lies proximate a first edge of a peripheral screen frame of the screen assembly, the screening machine further comprising a second rotary cam disposed proximate a second edge of said peripheral screen frame, said second edge being disposed opposite said first edge.

6. The screening machine of claim 1 wherein said at least one stop prevents rotation of said at least one rotary cam beyond about 110° from a lowest vertical position of said screen assembly and said vibratory carrier.

7. The screening machine of claim 1 wherein said at least one stop prevents rotary motion of said at least one rotary cam in one direction beyond a lowest vertical position of said screen assembly and said vibratory carrier.

8. The screening machine of claim 1 wherein said at least one rotary cam further comprises a surface portion configured to permit rotary motion of said at least one rotary cam beyond a highest vertical position of said screen assembly and said vibratory carrier.

9. The screening machine of claim 1 wherein said at least one rotary cam further comprises a surface portion configured such that a tool driving said actuator is in a generally horizontal orientation when said screen assembly and said vibratory carrier reach a highest vertical position.

10. The screening machine of claim 1 further comprising a bracket, wherein said at least one stop is integrally formed with said bracket.

11. A screening machine comprising:
a vibratory carrier;
a vibratory drive operatively coupled to said vibratory carrier for imparting vibratory motion to said vibratory carrier;
a screen assembly being selectively coupled to said vibratory carrier so that the vibratory motion is transmitted to said screen assembly;
a sealing mechanism including a compressible seal member disposed on said vibratory carrier, at least one rotary cam, and at least one actuator being accessible to a user of said screening machine and coupled to said rotary cam;
wherein actuation of said at least one actuator to rotate said at least one rotary cam compresses said seal member and urges said screen assembly and said vibratory carrier into sealing engagement with a confronting surface of said screening machine;
at least two stops positioned relative to said sealing mechanism to limit rotational movement of said at least one rotary cam in at least one direction.

12. The screening machine of claim 11 further comprising two rotary cams coupled to said at least one actuator.

13. The screening machine of claim 11 wherein said at least two stops further comprise a limiting cam coaxial with said at least one rotary cam.

14. The screening machine of claim 11 further comprising two stops positioned relative to said sealing mechanism to limit rotational movement of said at least one rotary cam in a clockwise direction and a counter-clockwise direction, respectively.

15. The screening machine of claim 11 wherein said at least one rotary cam lies proximate a first edge on said peripheral screen frame, the screening machine further comprising a second rotary cam disposed proximate a second edge on said peripheral screen frame, said second edge being disposed opposite said first edge.

16. The screening machine of claim 11 wherein one of said at least two stops prevents rotation of said at least one rotary cam beyond about 110° from a lowest vertical position of said screen assembly and said vibratory carrier.

17. The screening machine of claim 11 wherein one of said at least two stops prevents rotary motion of said at least one rotary cam in one direction beyond a lowest vertical position of said screen assembly and said vibratory carrier.

18. The screening machine of claim 11 wherein said at least one rotary cam further comprises a surface portion configured to permit rotary motion of said at least one rotary cam beyond a highest vertical position of said screen assembly and said vibratory carrier.

19. The screening machine of claim 11 wherein said at least one rotary cam further comprises a surface portion configured such that a tool driving said actuator is in a generally horizontal orientation when said screen assembly and said vibratory carrier reach a highest vertical position.

20. The screening machine of claim 11 further comprising a bracket, wherein said at least two stops are integrally formed with said bracket.

21. A method of sealing a screen assembly within a screening machine, the method comprising:
inserting the screen assembly into the screening machine relative to a vibratory carrier of the screening machine, the vibratory carrier imparting vibratory motion to the screen assembly during use of the screening machine;
rotating a rotary cam adapted to urge the vibratory carrier and screen assembly into and out of sealing engagement with corresponding portions of the screening machine; and
inhibiting the rotating the rotary cam with a stop positioned to restrict rotational movement of the rotary cam in at least one direction.

22. The method of claim 21 further comprising the step of:
rotating the rotary cam to urge the vibratory carrier and screen assembly out of sealing engagement with corresponding portions of the screening machine until a second stop is engaged to restrict movement of the rotary cam in a direction beyond a lowest height of the vibratory carrier and screen assembly.
